(19) United States
(12) Patent Application Publication
(10) Pub. No.: US 2025/0020417 A1
(43) Pub. Date: Jan. 16, 2025

(54) HEATER DEVICE

(71) Applicant: DENSO CORPORATION, Kariya-city (JP)

(72) Inventors: Yusuke KOMATSUBARA, Kariya-city (JP); Takayuki SHIMAUCHI, Kariya-city (JP); Toshiharu FUJII, Kariya-city (JP); Toru MORI, Kariya-city (JP)

(21) Appl. No.: 18/897,997

(22) Filed: Sep. 26, 2024

Related U.S. Application Data
(63) Continuation of application No. PCT/JP2023/011052, filed on Mar. 21, 2023.

(30) Foreign Application Priority Data
Mar. 30, 2022 (JP) 2022-055510

(51) Int. Cl. F28F 3/10

(52) U.S. Cl. CPC F28F 3/10; F28F 2275/025

(57) ABSTRACT

A heater device includes a flexible heat generating portion, a surface layer that covers a front side of the heat generating portion, and a heat insulating portion that covers a back side of the heat generating portion and blocks heat generated by the heat generating portion. The heat generating portion, the surface layer, and the heat insulating portion are configured as a laminate in which the surface layer, the heat generating portion, and the heat insulating portion are laminated in this order via an adhesive. The laminate has a plurality of slits for suppressing deformation due to differences in the linear expansion coefficients of the heat generating portion, the surface layer and the heat insulating portion.

### CROSS REFERENCE TO RELATED APPLICATIONS

This application is a continuation application of International Patent Application No. PCT/JP2023/011052 filed on Mar. 21, 2023, which designated the U.S. and based on and claims the benefits of priority of Japanese Patent Application No. 2022-055510 filed on Mar. 30, 2022. The entire disclosure of all of the above applications is incorporated herein by reference.

### TECHNICAL FIELD

The present disclosure relates to a heater device.

### BACKGROUND

Conventionally, a heater device includes a surface layer, a heat generating portion, and a heat insulating portion.

### SUMMARY

An object of the present disclosure is to provide a heater device that suppresses unintended deformation of a heater surface while ensuring the ability to conform to an external shape of an installation target.

According to one aspect of the present disclosure, a heater device includes a flexible heating portion, a surface layer covering a surface side of the heat generating portion, and a heat insulating portion that covers a back side of the heat generating portion and blocks heat generated by the heat generating portion. The heat generating portion, the surface layer, and the heat insulating portion are configured as a laminate in which the surface layer, the heat generating portion, and the heat insulating portion are laminated in this order via an adhesive. The laminate has a plurality of slits for suppressing deformation due to differences in the linear expansion coefficients of the heat generating portion, the surface layer and the heat insulating portion.

### BRIEF DESCRIPTION OF DRAWINGS

FIG. 1 is a schematic diagram showing a vehicle interior space in a state in which a heater device according to a first embodiment is installed;

FIG. 2 is a schematic perspective view of the heater device according to the first embodiment;

FIG. 3 is a schematic cross-sectional view of a heater main body of the heater device according to the first embodiment;

FIG. 4 is an explanatory diagram for explaining thermal stress etc. that occurs when a heat generating portion of a heater device according to a first comparative example generates heat;

FIG. 5 is an explanatory diagram for explaining deformation caused when the heat generating portion of the heater device according to the first comparative example generates heat;

FIG. 6 is a schematic plan view of a part VI in FIG. 3;

FIG. 7 is a cross-sectional view taken along a line VII-VII of FIG. 6;

FIG. 8 is an explanatory diagram for explaining thermal stress etc. that occurs when the heat generating portion of the heater device according to the first embodiment generates heat;

FIG. 9 is an explanatory diagram for explaining thermal stress etc. that occurs when the heat generating portion of the heater device according to a first modified example of the first embodiment generates heat;

FIG. 10 is an explanatory diagram for explaining thermal stress etc. that occurs when the heat generating portion of the heater device according to a second modified example of the first embodiment generates heat;

FIG. 11 is an explanatory diagram for explaining thermal stress etc. that occurs when the heat generating portion of the heater device according to a third modified example of the first embodiment generates heat;

FIG. 12 is an explanatory diagram for explaining thermal stress etc. that occurs when the heat generating portion of the heater device according to a fourth modified example of the first embodiment generates heat;

FIG. 13 is an explanatory diagram for explaining thermal stress etc. that occurs when the heat generating portion of the heater device according to a fifth modified example of the first embodiment generates heat;

FIG. 14 is a schematic perspective view of the heater device according to a second embodiment;

FIG. 15 is an explanatory diagram for explaining deformation caused when the heat generating portion of the heater device according to a second comparative example generates heat;

FIG. 16 is a schematic plan view of a heat insulating portion of the heater device according to the second embodiment;

FIG. 17 is a schematic cross-sectional view of a heater main body of the heater device according to a third embodiment; and

FIG. 18 is a schematic cross-sectional view of a heater main body of the heater device according to a fourth embodiment.

### DETAILED DESCRIPTION

In an assumable example, a heater device includes a surface layer, a heat generating portion, and a heat insulating portion. In this type of heater device, the surface layer, the heat generating portion, and the heat insulating portion are laminated in this order with a curable adhesive therebetween.

In order to realize a heater device that can be installed in a manner that is suitable for an external shape of an installation target, the discloser have investigated a structure in which the surface layer and the heat insulating portion are attached to a flexible heat generating portion with an adhesive.

However, in a case where the surface layer and the heat insulating portion are attached to the heat generating portion with adhesive, the disclosers found that when the heat generating portion generates heat, unintended deformation of the heater surface is likely to occur due to thermal stress due to the difference in linear expansion coefficient of each component. Such unintended deformation is undesirable since it can reduce the design quality of the product or the installation target.

On the other hand, one possible measure to avoid the effects of thermal stress is to not adhere the heat generating portion to the surface layer and the heat insulating portion. However, in this case, unintended gaps are likely to form between the surface layer, the heat generating portion, and the heat insulating portion. This phenomenon is undesirable because it causes a decrease in the ability to follow the external shape of the installation target. An object of the present disclosure is to provide a heater device that suppresses unintended deformation of the heater surface while ensuring the ability to conform to the external shape of the installation target.

According to one aspect of the present disclosure, a heater device includes a flexible heating portion, a surface layer covering a surface side of the heat generating portion, and a heat insulating portion that covers a back side of the heat generating portion and blocks heat generated by the heat generating portion. The heat generating portion, the surface layer, and the heat insulating portion are configured as a laminate in which the surface layer, the heat generating portion, and the heat insulating portion are laminated in this order via an adhesive. The laminate has a plurality of slits for suppressing deformation due to differences in the linear expansion coefficients of the heat generating portion, the surface layer and the heat insulating portion.

In this way, by laminating the surface layer and the heat insulating portion to the flexible heat generating portion with the adhesive, the formation of unintended gaps between the surface layer, the heat generating portion, and the heat insulating portion is prevented, thereby ensuring the ability to conform to the external shape of an installation target. In addition, the plurality of slits are provided in the laminate of the surface layer, the heat generating portion, and the heat insulating portion. Therefore, since the laminate is given elasticity and the thermal stress caused by the difference in the linear expansion coefficient of each component is alleviated by the plurality of slits, deformation due to the difference in the linear expansion coefficient of each component can be suppressed.

Therefore, in the heater device of the present embodiment, it is possible to suppress the occurrence of unintended deformation of the heater surface while ensuring the ability to be suitable for the external shape of the installation target.

Here, the “adhesive” is also called a pressure-sensitive adhesive. An “adhesive” is something that maintains its viscosity even over time, and is clearly distinguished from a curing adhesive that hardens over time. The curing adhesive is expected to suppress deformation due to differences in the linear expansion coefficient due to their hardening properties, but they do not satisfy the heat resistance required for heater devices and have odor problems due to volatile components, so they cannot be used. In addition, in this specification, “flexible” refers to the property that an object is soft and can be bent. Furthermore, the term “slit” in this specification refers to a cut or narrow gap, and includes not only those that do not penetrate an object but also those that penetrate an object, and may be straight, curved, L-shaped, X-shaped, etc., and there is no particular limitation on its length, etc.

Hereinafter, embodiments of the present disclosure will be described with reference to the drawings. In the following embodiments, parts, which are the same as or equivalent to those described in the preceding embodiment(s), will be indicated by the same reference signs, and the description thereof may be omitted. Also, in the following embodiments, when only some of the constituent elements are described, corresponding constituent elements of a previously described one or more of the embodiments may be applied to the rest of the constituent elements. The respective embodiments described herein may be partially combined with each other as long as no particular problems are caused even without explicit statement of these combinations.

### First Embodiment

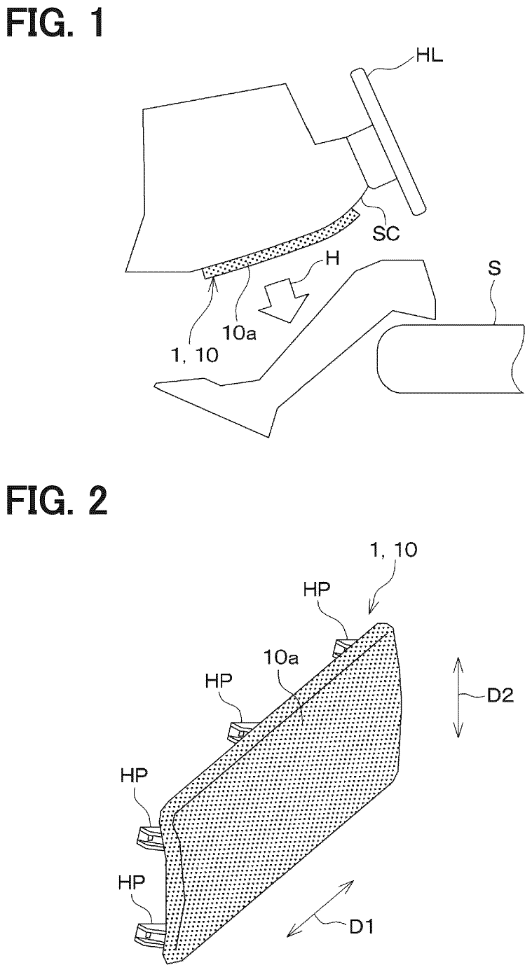

The present embodiment will be described with reference to FIGS. 1 to 8. In the present embodiment, an example in which a heater device 1 of the present disclosure is applied to a heating device that heats the interior of a vehicle will be described.

The heater device 1 includes a sheet-shaped heater main body 10 and a heater control unit (not shown). The heater main body 10 is disposed below a steering column SC that supports a steering wheel HL. The heater main body 10 radiates radiant heat H from the heater surface 10a toward the feet of an occupant seated in a seat S. In the present embodiment, the steering column SC is an installation target of the heater device 1. The heater control unit is a control unit that controls an operation of the heater main body 10. The heater control unit includes a microcomputer having a processor and a memory, and its peripheral circuits.

As shown in FIG. 2, the heater main body 10 has a substantially rectangular external shape on the heater surface 10a side. The heater main body 10 is installed in a position in which its long dimension direction D1 extends along a width direction of the vehicle. The heater main body 10 may be installed, for example, in a position in which a short dimension direction D2 extends along the width direction of the vehicle.

The heater main body 10 is provided with a plurality of claw portions HP on the back side of the heater surface 10a for mounting to the installation target. The heater main body 10 is fixed to the installation target by attaching the claw portion HP to the installation target.

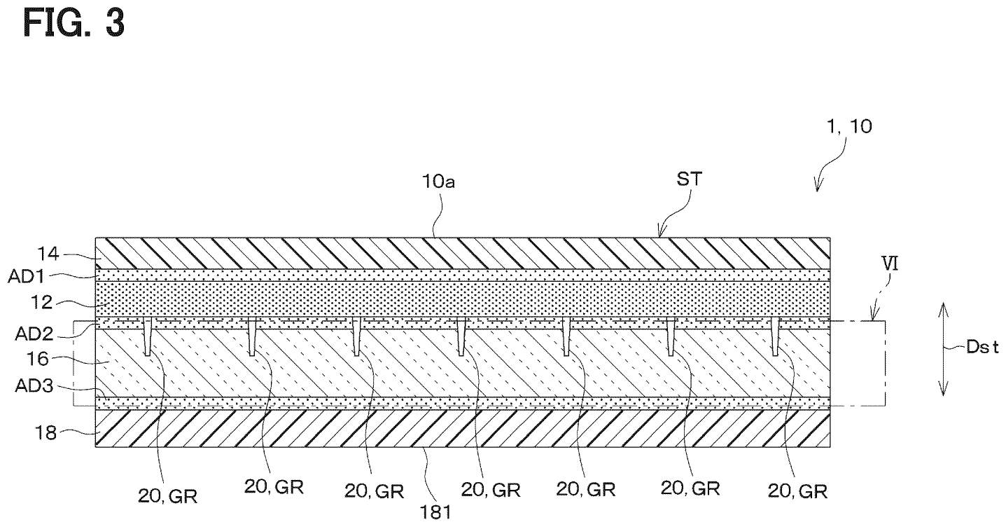

As shown in FIG. 3, the heater main body 10 includes a flexible heat generating portion 12, a surface layer 14, a heat insulating portion 16, and a case portion 18. The heat generating portion 12, the surface layer 14, and the heat insulating portion 16 are arranged in this order from the heater surface 10a side.

The heat generating portion 12 is a heater that generates heat by itself when current is applied and radiates radiant heat H. The heat generating portion 12 of the present embodiment is configured as a film heater in which a heat generating element is mounted on a thin flexible substrate so that it can be adapted to the external shape of the installation target.

The surface layer 14 is disposed on the surface side of the heat generating portion 12 and covers the surface side of the heat generating portion 12. The surface layer 14 is located at the outermost side of the heater main body 10. A surface of the surface layer 14 constitutes the heater surface 10a. The surface layer 14 is made of a material having a linear expansion coefficient smaller than that of the material of the heat generating portion 12. Specifically, the surface layer 14 is made of a fabric material. The fabric material is made of, for example, resin fibers such as polyester fibers.

The heat insulating portion 16 is disposed between the heat generating portion 12 and the installation target, and suppresses heat transfer due to thermal conduction from the heat generating portion 12 to the installation target. The heat insulating portion 16 is disposed on the rear surface side of the heat generating portion 12 and covers the rear surface side of the heat generating portion 12. The heat insulating portion 16 blocks the heat generated by the heat generating portion 12. The heat insulating portion 16 is made of a material having a linear expansion coefficient smaller than that of the material of the heat generating portion 12. Specifically, the heat insulating portion 16 is made of a resin material such as urethane foam. The heat insulating portion 16 has a certain degree of flexibility so that it can conform to the external shape of the installation target.

The case portion 18 holds a laminate ST consisting of the surface layer 14, the heat generating portion 12, and the heat insulating portion 16. The case portion 18 has a bottom part 181 disposed on the rear surface side of the heat insulating portion 16. The bottom part 181 has the afore-mentioned claw portions HP disposed on the side opposite the heat insulating portion 16. The case portion 18 is made of a synthetic resin or the like.

Here, in a case where the heat generating portion 12 is not adhered to the surface layer 14 and the heat insulating portion 16, when the heater device 1 is installed on the installation target, unintended gaps are likely to form between the surface layer 14 and the heat generating portion 12, and between the heat generating portion 12 and the heat insulating portion 16. This phenomenon is undesirable because it causes a decrease in the ability to follow the external shape of the installation target. For example, in a case where the heater main body 10 is placed near the occupant, as in the present embodiment, it is sometimes required to follow designs that include curved surfaces. However, when the heat generating portion 12 is not bonded to the surface layer14 and the heat insulating portion 16, it is not possible to correspond to a design surface including a concave shape.

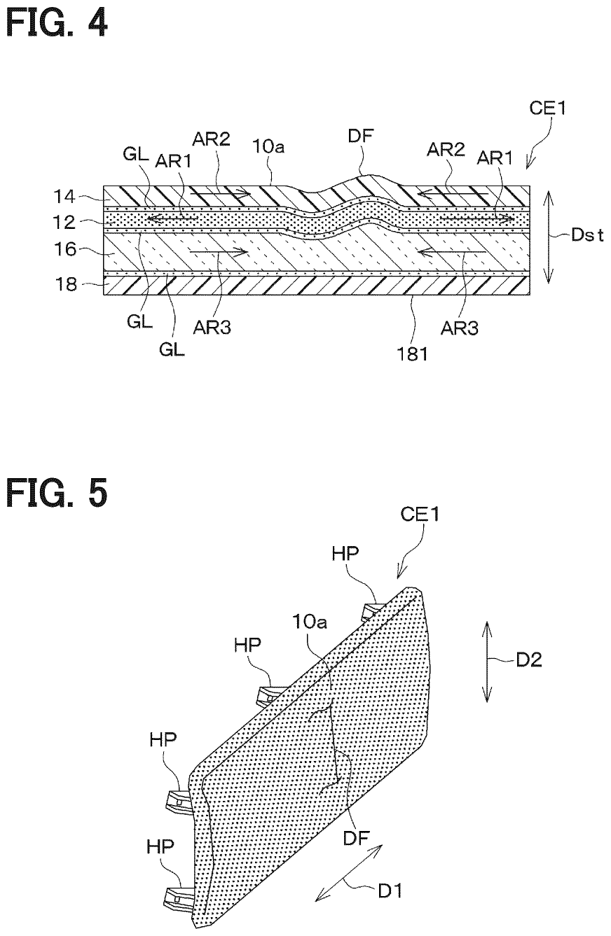

On the contrary, for example, as in a heater device CE1 of a first comparative example shown in FIG. 4, it is conceivable to bond the surface layer 14 and the heat insulating portion 16 to the heat generating portion 12 with adhesive GL. In FIG. 4, the same reference numerals as those in the heater device 1 of the present embodiment are used for the components of the heater device CE1 of the first comparative example that correspond to those in the heater device 1 of the present embodiment.

In the heater device CE1 of the first comparative example, when the heat generating portion 12 generates heat, the heat generating portion 12 tends to expand in the direction of an arrow AR1. On the other hand, when the heat generating portion 12 generates heat, the surface layer 14 attempts to expand in response to the heat from the heat generating portion 12, but since the surface layer 14 has a smaller linear expansion coefficient than the heat generating portion 12, a force acts on the surface layer 14 to cause it to contract in the direction of the arrow AR2. Similarly, when the heat generating portion 12 generates heat, the heat insulating portion 16 attempts to expand in response to the heat from the heat generating portion 12, but because the linear expansion coefficient of the heat insulating portion 16 is smaller than that of the heat generating portion 12, a force acts to contract the heat insulating portion 16 in the direction of the arrow AR3.

For this reason, in the heater device CE1 of the first comparative example, distortion occurs in the heat generating portion 12 due to thermal stress caused by differences in the linear expansion coefficients of each component, and unintended deformations DF such as unevenness and wrinkles are likely to occur on the heater surface 10a, for example, as shown in FIG. 5. Such unintended deformations DF are undesirable since it can reduce the design quality of the product or the installation target.

Furthermore, according to the disclosers' investigations, it has been found that the unintended deformation DF tends to occur easily in a direction intersecting with the long dimension direction D1.

Taking these factors into consideration, as shown in FIG. 3, the heater device 1 is configured as a laminate ST in which the heat generating portion 12, the surface layer 14, and the heat insulating portion 16 are laminated in this order, with adhesives AD1 and AD2 interposed between the surface layer 14 and the heat generating portion 12, and between the heat generating portion 12 and the heat insulating portion 16. The laminate ST has the multiple slits 20 for suppressing deformation DF caused by differences in the linear expansion coefficients of the heat generating portion 12 and the surface layer 14 and the heat insulating portion 16. The heat insulating portion 16 is attached to the case portion 18 with an adhesive AD3.

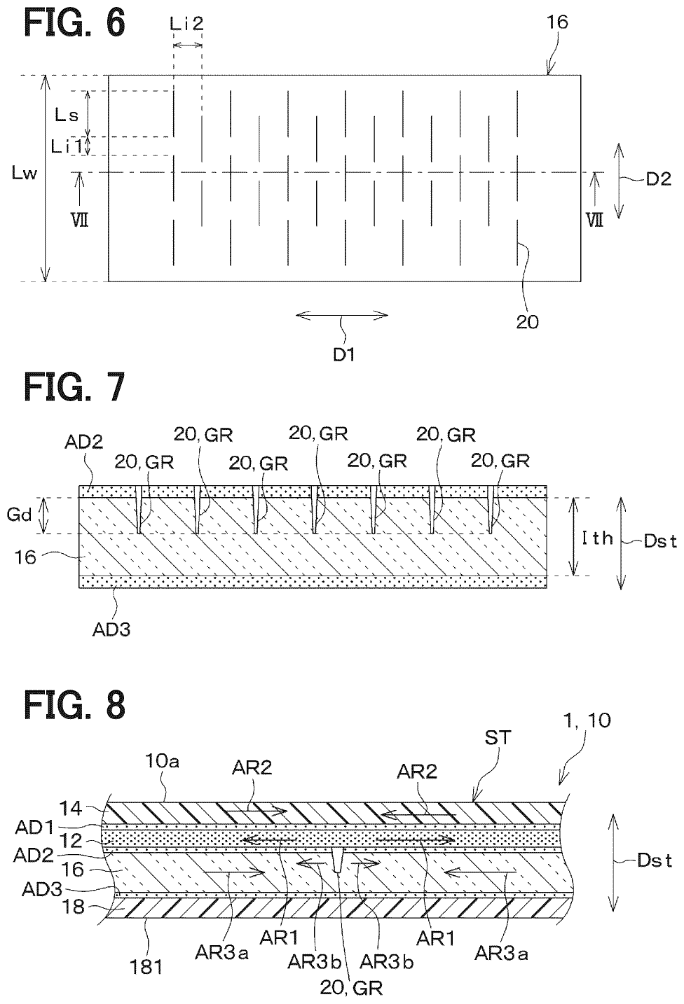

As shown in FIG. 6, the heater device 1 has the multiple slits 20 formed in the heat insulating portion 16. The multiple slits 20 are formed on the surface of the heat insulating portion 16 facing the heat generating portion 12 so as to extend along a predetermined direction.

In the laminate ST of the present embodiment, a dimension in a “predetermined direction” in a plane perpendicular to a stacking direction Dst of the laminate ST is larger than the dimension in an “other direction.” In the present embodiment, a long dimension direction D1 of the heater main body 10 corresponds to the “predetermined direction”, and a short dimension direction D2 of the heater main body 10 corresponds to the “other direction”.

The multiple slits 20 extend in a direction intersecting the long dimension direction D1, which is the “predetermined direction”. Specifically, the multiple slits 20 extend along the short dimension direction D2, which is the “other direction”.

In the multiple slits 20, the dimension Ls of the slit 20 in the long side direction is set so that the multiple slits 20 can be provided in the long side direction of the slit 20. In the slit 20 of the present embodiment, the dimension Ls in the long side direction is equal to or less than half the dimension Lw of the heater main body 10 in the short dimension direction D2. When the dimension Ls of the slit 20 in the long side direction is too large, the shape of the heat insulating portion 16 will not be stable and the shape of the heat insulating portion 16 will easily collapse. Therefore, it is desirable that the dimension Ls of the slit 20 in the long side direction is one third (⅓) or less of the dimension Lw of the heater main body 10 in the short dimension direction D2. The multiple slits 20 may have the same dimension Ls in the long side direction or may have different dimensions.

The multiple slits 20 are arranged in a staggered pattern such that adjacent slits in the short direction of the slits 20 are shifted in the long direction of the slits 20. For example, the slits 20 adjacent to each other in the short-side direction of the slit 20 are arranged such that the ends in the long-side direction of the slits 20 do not coincide with each other in the short-side direction of the slit 20.

An interval between adjacent slits 20 is smaller than the dimension Ls of the slits 20 in the long side direction. Specifically, the interval Li1 between adjacent slits 20 in the long side direction of the slits 20 is smaller than the dimension Ls of the slits 20 in the long side direction. Further, the interval Li2 between adjacent slits 20 in the short side direction of the slits 20 is smaller than the dimension Ls of the slits 20 in the long side direction. In addition, one of the interval Li1 between adjacent slits 20 in the long side direction of the slits 20 and the interval Li2 between adjacent slits 20 in the short side direction of the slits 20 may be greater than or equal to the dimension Ls of the slits 20 in the long side direction.

As shown in FIG. 7, the multiple slits 20 are configured as bottomed grooves GR rather than through holes TH. The bottomed groove GR is formed in a portion of the heat insulating portion 16 facing the heat generating portion 12. When a groove depth Gd of the bottomed groove GR is too large, the shape of the heat insulating portion 16 will not be stable, and the shape of the heat insulating portion 16 will easily loose. Therefore, it is desirable that the groove depth Gd of the bottomed groove GR is less than half the thickness Ith of the heat insulating portion 16 in the laminating direction Dst of the laminate ST.

In the heater device 1 configured in this manner, when the heat generating portion 12 generates heat, the heat insulating portion 16 tends to contract in the direction of the arrow AR3a due to the difference in linear expansion coefficient with the heat generating portion 12. However, at the portion where the slit 20 is provided, it tries to be displaced in the direction of arrow AR3b, which is opposite to arrow AR3a. That is, the heat insulating portion 16 can easily follow the expansion of the heat generating portion 12 in a vicinity of the slits 20. In this case, the thermal stress caused by the difference in the linear expansion coefficient between the heat generating portion 12 and the heat insulating portion 16 is alleviated, so that unintended deformation DF such as unevenness or wrinkles is less likely to occur on the heater surface 10a.

According to the disclosers' investigation, in the heater device 1 of the first comparative example, when the heat generating portion 12 generates heat, the disclosers found that the amount of deformation in the laminating direction Dst, such as wrinkles, occurring on the heater surface 10a was 0.3 mm or more, which easily affected the good looking and appearance of the heater surface 10a.

In contrast, in the heater device 1 of the present embodiment, when the heat generating portion 12 generates heat, the deformation amount in the laminating direction Dst of wrinkles and the like that occurs on the heater surface 10a is 0.2 mm or less, and it was found that there was almost no effect on the good looking or appearance of the heater surface 10a.

In the heater device 1 described above, the surface layer 14 and the heat insulating portion 16 are pasted and laminated to the flexible heat generating portion 12 with adhesives AD1 and AD2. With this configuration, the formation of unintended gaps between the surface layer 14 and the heat generating portion 12, and between the heat generating portion 12 and the insulation portion 16 is suppressed, thereby ensuring the ability to conform to the external shape of the installation target. Even if the steering column SC as the installation target has a concave shape, the heater device 1 of the present embodiment can be made into a shape suitable for the shape of the steering column SC.

In addition, a plurality of slits 20 are provided in the laminate ST consisting of the surface layer 14, the heat generating portion 12, and the heat insulating portion 16. According to this configuration, by imparting elasticity to the laminate ST, the thermal stress due to the difference in linear expansion coefficient of each component is alleviated in the plurality of slits 20. Therefore, deformation DF due to differences in linear expansion coefficients of each component can be suppressed.

Therefore, in the heater device 1 of the present embodiment, it is possible to suppress the occurrence of unintended deformation DF of the heater surface 10a while ensuring the ability to be suitable for the external shape of the installation target. The heater device 1 of the present embodiment does not require an increase in the number of components, and therefore, improved productivity and reduced costs can be expected.

Moreover, the heater device 1 of the present embodiment has the following features.

(1) The multiple slits 20 are configured as bottomed grooves GR formed in the heat insulating portion 16. In this manner, when the multiple slits 20 are configured as bottomed grooves GR, the shape of the heat insulating portion 16 is easily maintained. Therefore, it is also very effective in suppressing the occurrence of unintended deformation DF due to differences in linear expansion coefficients of each component. Furthermore, the fact that the shape of the heat insulating portion 16 is easily maintained also contributes to improved productivity. The same applies to the case where a plurality of bottomed slits 20 are provided in the heat generating portion 12 and the surface layer 14.

(2) The multiple slits 20 are provided in the heat insulating portion 16 of the laminate ST. According to this configuration, the multiple slits 20 provided in the heat insulating portion 16 can suppress unintended deformation DF caused by the difference in linear expansion coefficient between the heat generating portion 12 and the heat insulating portion 16.

(3) The multiple slits 20 are formed on the surface of the heat insulating portion 16 facing the heat generating portion 12 so as to extend along a predetermined direction. According to this configuration, the slits 20 can relieve the thermal stress acting in a direction intersecting a predetermined direction, so that the deformation DF due to the thermal stress can be suppressed.

(4) Specifically, the multiple slits 20 extend in a direction intersecting the long dimension direction D1. According to this configuration, the slits 20 can relieve the thermal stress acting in the long dimension direction D1, so that the occurrence of deformation DF of the heater surface 10a caused by the thermal stress can be suppressed.

(5) At least some of the multiple slits 20 have the dimension Ls in the long side direction set so that a plurality of slits 20 can be provided in the long side direction of the slits 20. For example, when the slit 20 is provided so as to extend from one end to the other end in the long dimension direction D1 of the heat insulating portion 16, the shape of the heat insulating portion 16 will not be stable and will be prone to deformation. On the other hand, when the dimension Ls of the slit 20 in the long side direction is set to a dimension that allows the multiple slits 20 to be provided in the direction of the slits 20 in the long side direction, the shape of the heat insulating portion 16 is easily maintained. This is also very effective in suppressing the occurrence of deformation DF of the heater surface 10a due to thermal stress.

(6) In at least some of the multiple slits 20, the distance between adjacent slits 20 is smaller than the dimension Ls of the slits 20 in the long side direction. In this way, when the distance between adjacent slits 20 is small, it becomes easier to alleviate thermal stress caused by differences in the linear expansion coefficients of each component, and the occurrence of deformation DF of the heater surface 10a caused by such thermal stress can be suppressed.

(7) The multiple slits 20 are arranged such that adjacent slits in the short side direction of the slits 20 are shifted from each other in the long side direction of the slits 20. In this way, by arranging multiple slits 20 in a staggered pattern, it becomes easier to alleviate thermal stress caused by differences in the linear expansion coefficients of each component, thereby suppressing the occurrence of deformation DF of the heater surface 10a caused by the thermal stress.

### First Modified Example of First Embodiment

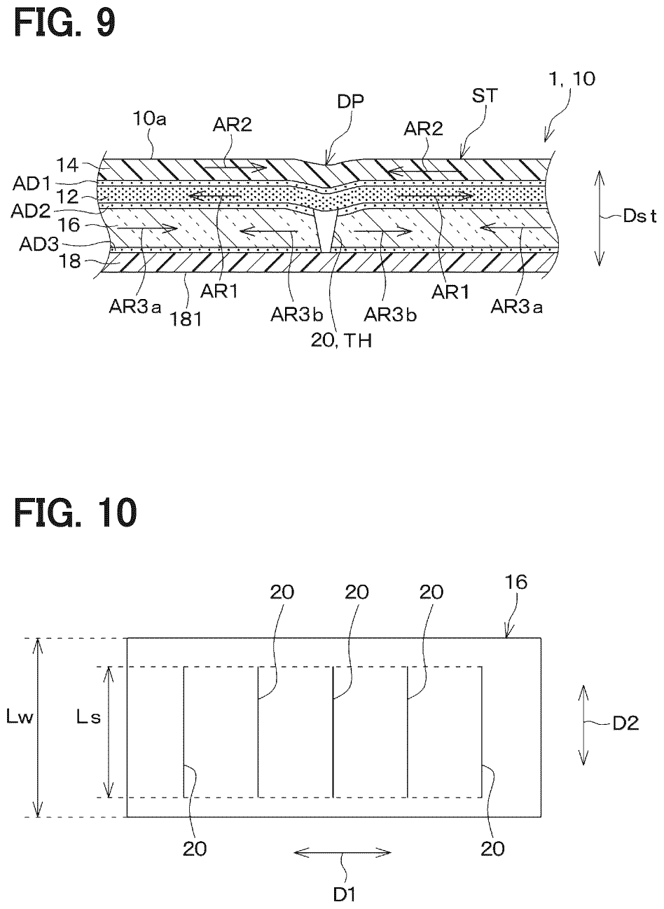

The multiple slits 20 may not be bottomed grooves GR, but may be formed of through holes TH that penetrate the heat insulating portion 16 from the front to the back as shown in FIG. 9, for example. In the heater device 1 configured in this manner, when the heat generating portion 12 generates heat, the heat insulating portion 16 tends to contract in the direction of the arrow AR3a due to the difference in linear expansion coefficient with the heat generating portion 12. However, at the portion where the slit 20 is provided, it tries to be displaced in the direction of arrow AR3b, which is opposite to arrow AR3a. That is, the heat insulating portion 16 can easily follow the expansion of the heat generating portion 12 in a vicinity of the slits 20. In this case, the thermal stress caused by the difference in the linear expansion coefficient between the heat generating portion 12 and the heat insulating portion 16 is alleviated, so that unintended deformation DF such as unevenness or wrinkles is less likely to occur on the heater surface 10a.

However, when the multiple slits 20 are formed by through holes TH, the parts separated by the slits 20 are no longer constrained from each other, so the shape of the component in which the slits 20 are provided becomes unstable and the shape of the component becomes easily distorted. This is undesirable since it may cause a slight depression DP or the like to occur on the heater surface 10a. For this reason, it is desirable that each of the multiple slits 20 is configured as the bottomed groove GR.

### Second Modified Example of First Embodiment

The multiple slits 20 described in the first embodiment have the dimension Ls in the long side direction that is equal to or less than half the dimension Lw of the heat insulating portion 16 in the short dimension direction D2, but are not limited to this configuration. For example, as shown in FIG. 10, the dimension Ls in the long side direction of each of the multiple slits 20 may be greater than half the dimension Lw of the heat insulating portion 16 in the short dimension direction D2. In FIG. 10, in order to avoid complicating the drawing, only one of the multiple slits 20 is indicated by a reference symbol.

### Third Modified Example of First Embodiment

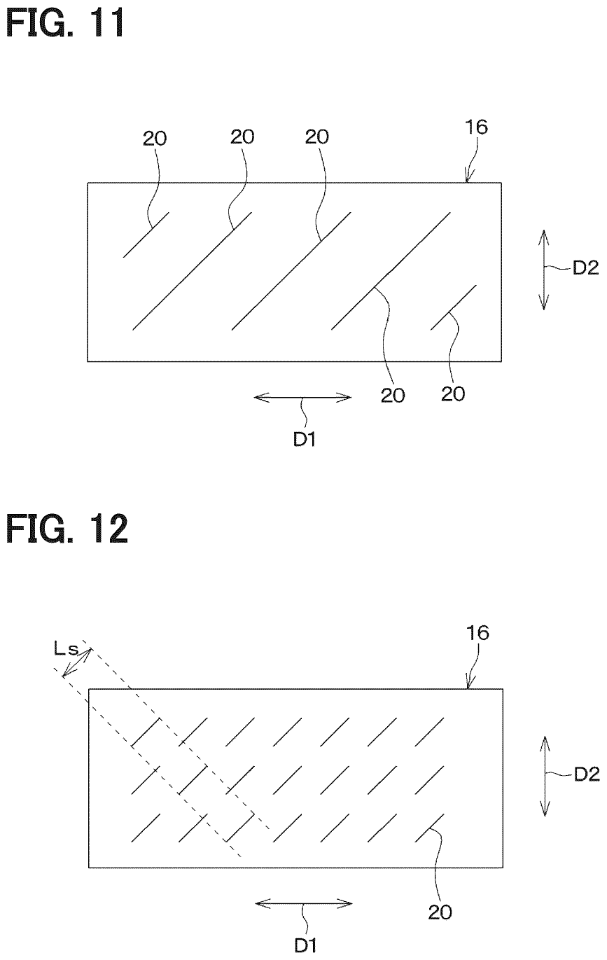

Although the multiple slits 20 described in the first embodiment extend along the short dimension direction D2, the present disclosure is not limited to this configuration. For example, as shown in FIG. 11, the multiple slits 20 may extend along a direction intersecting both the long dimension direction D1 and the short dimension direction D2.

### Fourth Modified Example of First Embodiment

When the multiple slits 20 extend in a direction inclined with respect to the long dimension direction D1, it is desirable that the multiple slits 20 be arranged in a staggered pattern, for example, as shown in FIG. 12. In this case, in the multiple slits 20, it is preferable that the dimension Ls of the slit 20 in the long side direction is set so that the multiple slits 20 can be provided in the long side direction of the slit 20. In FIG. 12, in order to avoid complicating the drawing, only one of the multiple slits 20 is indicated by a reference symbol.

### Fifth Modified Example of the First Embodiment

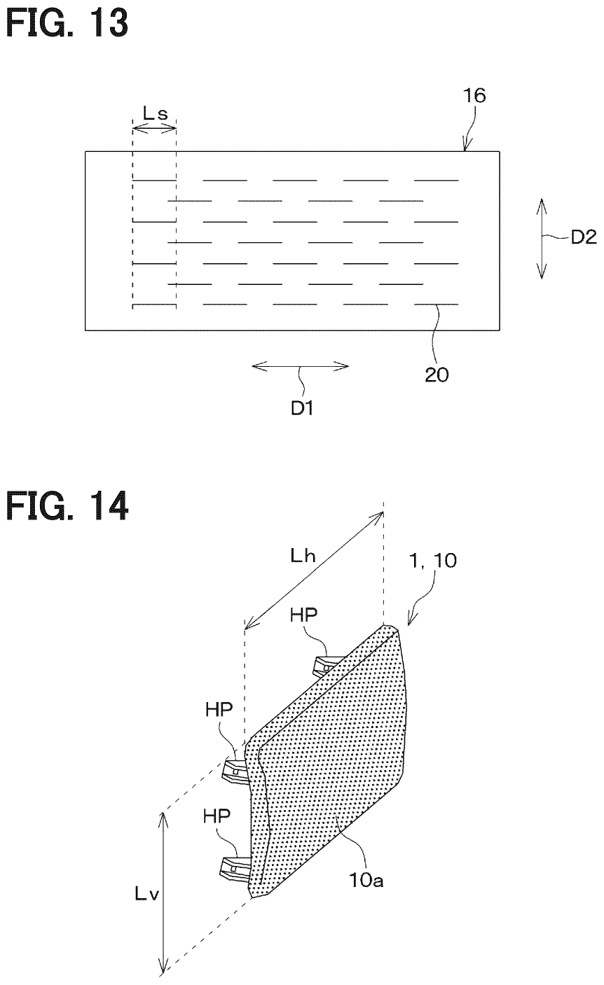

The multiple slits 20 described in the first embodiment extend along the short dimension direction D2, but the multiple slits 20 are not limited to this configuration. For example, as shown in FIG. 13, the multiple slits 20 may extend along the long dimension direction D1. In this case, in the multiple slits 20, it is preferable that the dimension Ls of the slit 20 in the long side direction is set so that the multiple slits 20 can be provided in the long side direction of the slit 20. In FIG. 13, in order to avoid complicating the drawing, only one of the multiple slits 20 is indicated by a reference symbol.

### Second Embodiment

Next, a second embodiment will be described with reference to FIGS. 14 to 16. In the present embodiment, differences from the first embodiment will be mainly described.

As shown in FIG. 14, the heater main body 10 of the present embodiment has an outer shape on the heater surface 10a side that is substantially square. That is, the heater main body 10 has a vertical dimension Lv and a horizontal dimension Lh that are approximately the same.

Here, in the heater main body 10 having the shape shown in FIG. 14, a heater device CE2 of a second comparative example is obtained by bonding the surface layer 14 and the heat insulating portion 16 to the heat generating portion 12 using the adhesive GL.

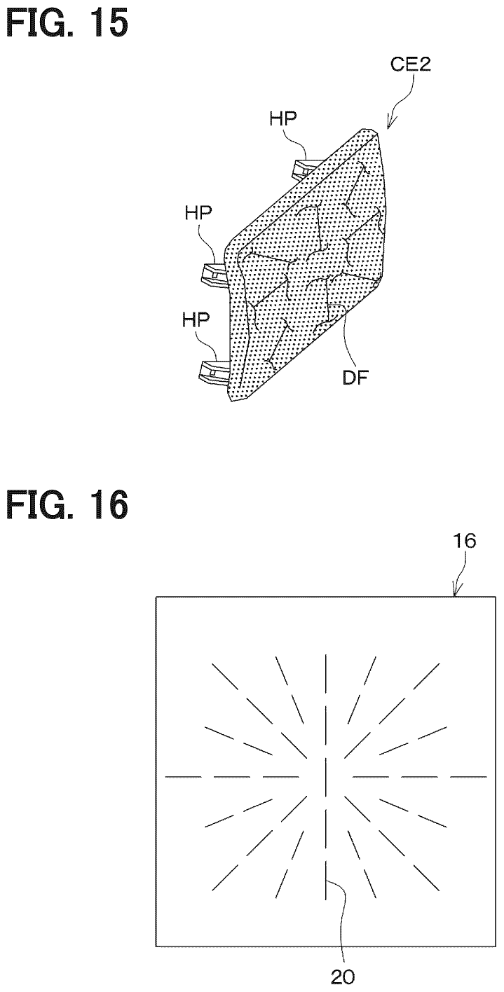

According to the research and study of the present disclosers, it was found that in the heater device CE2 of the second comparative example, when the heat generating portion 12 generates heat, as shown in FIG. 15, unintended deformations DF such as wrinkles and unevenness tend to occur radially from approximately the center of the heater surface 10a.

Taking this into consideration, the heater device 1 of the present embodiment has the multiple slits 20 extending along a predetermined number of directions on the opposing surface of the heat insulating portion 16 facing the heat generating portion 12 corresponding to the deformations DF formed in various directions. Specifically, as shown in FIG. 16, the multiple slits 20 are formed so as to extend radially from approximately the center of the heater surface 10a. In FIG. 16, in order to avoid complicating the drawing, only one of the multiple slits 20 is indicated by a reference symbol.

Others are the same as those in the first embodiment. The heater device 3 in the present embodiment can achieve the effects obtained from the common configuration or the equivalent configuration to the first embodiment.

Moreover, the heater device 1 of the present embodiment has the following features.

(1) The multiple slits 20 are formed on the surface of the heat insulating portion 16 facing the heat generating portion 12 so as to extend along multiple predetermined directions. According to this configuration, the slits 20 can relieve the thermal stress acting in a direction intersecting the multiple predetermined directions, so that the deformation DF due to the thermal stress can be suppressed. For example, in the heater device 1 of the present embodiment, the deformation DF as shown in FIG. 15 can be suppressed.

### Modified Example of Second Embodiment

In the second embodiment, the multiple slits 20 are formed to extend radially from approximately the central portion of the heater surface 10a, but the multiple slits 20 are not limited to this configuration and they may be formed to extend in directions different from that described above.

### Third Embodiment

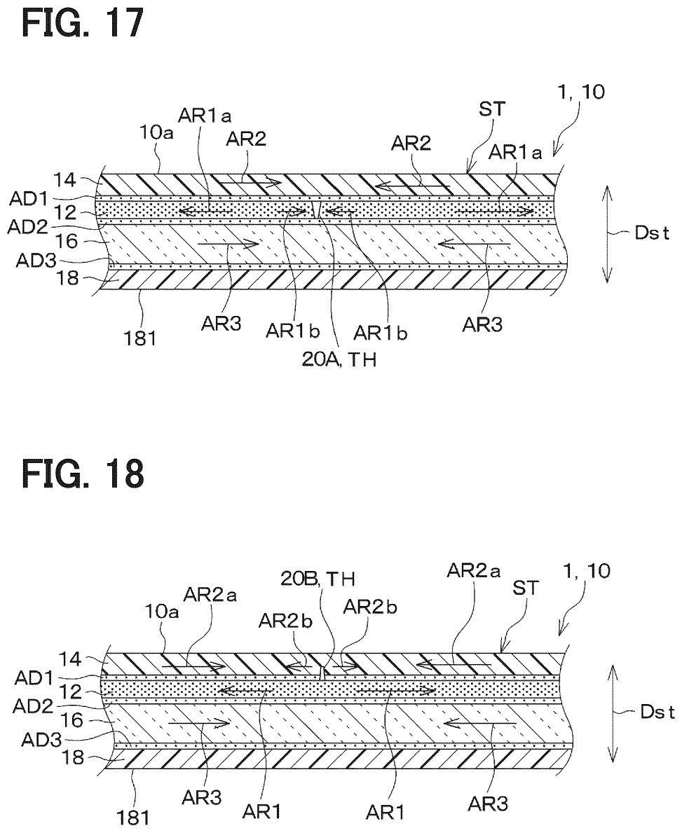

Next, a third embodiment will be described with reference to FIG. 17. In the present embodiment, differences from the first embodiment will be mainly described.

As shown in FIG. 17, in the laminate ST, a plurality of slits 20A are provided in the heat generating portion 12, not in the heat insulating portion 16. The heat generating portion 12 includes a heat generating element, electrical wiring, and the like, and therefore, unlike the heat insulating portion 16, the shape of the heat generating portion 12 is easily maintained even when the slits 20A are formed in the heat generating portion 12. Therefore, the slits 20A are configured as the through hole TH rather than the bottomed groove GR. The dimensions, arrangement, etc. of the slits 20A are similar to those of the slits 20 described in the first embodiment, and therefore the description thereof will be omitted.

In the heater device 1 thus configured, when the heat generating portion 12 generates heat, the heat generating portion 12 attempts to expand in the direction of the arrow AR1a. However, at the portion where the slit 20A is provided, it tries to be displaced in the direction of the arrow AR1b, which is opposite to the arrow AR1a. In this case, the expansion of the heat generating portion 12 is suppressed, and thermal stress due to the difference in the linear expansion coefficients of the heat generating portion 12, the surface layer 14, and the heat insulating portion 16 is alleviated. Therefore, this makes it difficult for unintended deformations DF such as unevenness and wrinkles to occur on the heater surface 10a.

Others are the same as those in the first embodiment. The heater device 3 in the present embodiment can achieve the effects obtained from the common configuration or the equivalent configuration to the first embodiment.

Moreover, the heater device 1 of the present embodiment has the following features.

(1) The multiple slits 20A are provided in the heat generating portion 12 of the laminate ST. According to this configuration, thermal stress due to the difference in linear expansion coefficient between the heat generating portion 12 and the heat insulating portion 16, or thermal stress due to the difference in linear expansion coefficient between the heat generating portion 12 and the surface layer 14, can be alleviated by the multiple slits 20A provided in the heat generating portion 12. As a result, unintended deformation DF due to differences in the linear expansion coefficients of the components of the laminate ST can be suppressed.

### Modified Example of Third Embodiment

The multiple slits 20A may be configured as, for example, bottomed grooves GR instead of through holes TH. This bottomed groove GR may be formed in at least one of a portion of the heat generating portion 12 facing the heat insulating portion 16 and a portion of the heat generating portion 12 facing the surface layer 14. The multiple slits 20A may be formed in the manners shown in the second to fifth modified examples of the first embodiment.

In the laminate ST of the third embodiment, the slits 20B are provided in the heat generating portion 12. For example, the multiple slits 20 may be provided not only in the heat generating portion 12 but also in the heat insulating portion 16.

### Fourth Embodiment

Next, a fourth embodiment will be described with reference to FIG. 18. In the present embodiment, differences from the first embodiment will be mainly described.

As shown in FIG. 18, in the laminate ST, a plurality of slits 20B are provided in the surface layer 14, not in the heat insulating portion 16. Since the front surface side of the surface layer 14 becomes the heater surface 10a, the slit 20B is configured as a bottomed groove GR rather than a through hole TH. The bottomed groove GR is formed in a portion of the surface layer 14 facing the heat generating portion 12. The dimensions, arrangement, etc. of the slits 20B are similar to those of the slits 20 described in the first embodiment, and therefore the description thereof will be omitted.

In the heater device 1 configured in this manner, when the heat generating portion 12 generates heat, the surface layer 14 tends to contract in the direction of the arrow AR2a due to the difference in linear expansion coefficient with the heat generating portion 12. However, at the portion where the slit 20B is provided, it tries to be displaced in the direction of arrow AR2b, which is opposite to arrow AR2a. That is, the surface layer 14 can easily follow the expansion of the heat generating portion 12 in the vicinity of the slits 20B. In this case, the thermal stress caused by the difference in the linear expansion coefficient between the heat generating portion 12 and the surface layer 14 is alleviated, so that unintended deformation DF such as unevenness or wrinkles is less likely to occur on the heater surface 10a.

Others are the same as those in the first embodiment. The heater device 3 in the present embodiment can achieve the effects obtained from the common configuration or the equivalent configuration to the first embodiment.

Further, according to the present embodiment, the following advantages can be obtained.

(1) The multiple slits 20B are provided in the surface layer 14 of the laminate ST. According to this configuration, the thermal stress caused by the difference in linear expansion coefficient between the heat generating portion 12 and the surface layer 14 can be alleviated by the plurality of slits 20B provided in the surface layer 14. As a result, unintended deformation DF due to differences in the linear expansion coefficients of the components of the laminate ST can be suppressed.

### Modified Example of Fourth Embodiment

In the laminate ST of the fourth embodiment, the slits 20B are provided in the surface layer 14, but the present disclosure is not limited to this configuration. In the laminate ST, a plurality of slits 20A are provided in the surface layer 14. For example, the multiple slits 20A may be provided in the heat generating portion 12 and a plurality of slits 20 may be provided in the heat insulating portion 16. The multiple slits 20B may be formed in the manners shown in the second to fifth modified examples of the first embodiment.

### Other Embodiments

Although representative embodiments of the present disclosure have been described above, the present disclosure is not limited to the embodiments described above, and various modifications can be made, for example, as follows.

In the above embodiments, the components of the heater device 1 have been specifically described, but the heater device 1 may have some components different from those described above. For example, the heater main body 10 may have a shape other than a rectangle.

Although the heater main body 10 in the above-described embodiments includes the case portion 18, the case portion 18 is not an essential component and may be omitted. Further, although the heater main body 10 in the above-described embodiments is installed on the steering column SC, it may be installed, for example, on the instrument panel, the glove box, the back of the backrest portion of the seat S, etc.

In the above-described embodiments, an example has been described in which the heater device 1 of the present disclosure is applied to the heating device that warms the interior of a vehicle, but the heater device 1 of the present disclosure can also be widely applied to heating devices that warm the interior of a vehicle, portable heating devices, and the like.

In the embodiments described above, it is needless to say that the elements configuring the embodiments are not necessarily essential except in the case where those elements are clearly indicated to be essential in particular, the case where those elements are considered to be obviously essential in principle, and the like.

In the embodiments described above, the present disclosure is not limited to the specific number of components of the embodiments, except when numerical values such as the number, numerical values, quantities, ranges, and the like are referred to, particularly when it is expressly indispensable, and when it is obviously limited to the specific number in principle, and the like.

In the embodiments described above, when referring to the shape, positional relationship, and the like of a component and the like, it is not limited to the shape, positional relationship, and the like, except for the case where it is specifically specified, the case where it is fundamentally limited to a specific shape, positional relationship, and the like, and the like.

What is claimed is:

1. A heater device, comprising:
a flexible heat generating portion;
a surface layer configured to cover a surface side of the heat generating portion; and
a heat insulating portion configured to cover a rear side of the heat generating portion and block heat generated by the heat generating portion, wherein
the heat generating portion, the surface layer, and the heat insulating portion are configured as a laminate in which the surface layer, the heat generating portion, and the heat insulating portion are laminated in this order via an adhesive,
the laminate has a plurality of slits for suppressing a deformation caused by differences in linear expansion coefficients of the heat generating portion and the surface layer and the heat insulating portion, and
the adhesive is a pressure sensitive adhesive that maintains its viscosity over time.

2. The heater device according to claim 1, wherein
the plurality of slits are configured as bottomed grooves formed in at least one of the heat generating portion, the surface layer, and the heat insulating portion.

3. The heater device according to claim 1, wherein
the plurality of slits are provided in the heat insulating portion of the laminate.

4. The heater device according to claim 3, wherein
the plurality of slits are formed so as to extend along a predetermined direction on a surface of the heat insulating portion facing the heat generating portion.

5. The heater device according to claim 3, wherein
the plurality of slits are formed so as to extend along a plurality of predetermined directions on a surface of the heat insulating portion facing the heat generating portion.

6. The heater device according to claim 1, wherein
the laminate has a dimension in a predetermined direction in a plane perpendicular to a lamination direction of the laminate that is larger than dimensions in other directions, and
the plurality of slits extend in a direction intersecting the predetermined direction.

7. The heater device according to claim 1, wherein
the laminate has a dimension in a predetermined direction in a plane perpendicular to a lamination direction of the laminate that is larger than dimensions in other directions, and
the plurality of slits extend in a direction intersecting the predetermined direction.

8. The heater device according to claim 1, wherein
at least some of the plurality of slits have a dimension in a long side direction of the slits set so that the plurality of the slits are provided in the long side direction of the slits.

9. The heater device according to claim 1, wherein
in at least some of the plurality of slits, a distance between adjacent slits is smaller than a dimension in the long side direction of the slits.

10. The heater device according to claim 1, wherein
the plurality of slits are arranged such that adjacent ones in a short side direction of the slits are shifted from each other in a long side direction of the slits.

11. The heater device according to claim 1, wherein
the plurality of slits are provided in the heat generating portion of the laminate.

12. The heater device according to claim 1, wherein
the plurality of slits are provided in the surface layer of the laminate.
